(19) United States
(12) Patent Application Publication
(10) Pub. No.: US 2025/0073857 A1
(43) Pub. Date: Mar. 6, 2025

(54) SOCKET AND SOCKET SET WITH IDENTIFICATION

(71) Applicant: Snap-on Incorporated, Kenosha, WI (US)

(72) Inventors: Daniel M. Eggert, Kenosha, WI (US); Jeffrey M. Arendt, Union Grove, WI (US)

(73) Assignee: Snap-on Incorporated, Kenosha, WI (US)

(21) Appl. No.: 18/240,925

(22) Filed: Aug. 31, 2023

(51) Int. Cl. B25B 13/06

(52) U.S. Cl. CPC B25B 13/06

(57) ABSTRACT

Sockets of a socket set that each include markings for indicating socket size and distinguishing various size sockets from one another. The markings on a socket may include multiple numeric indicia on the outer surface of the socket in combination with one or more lines between the numeric indicia, where the number of lines is different between sockets that are adjacent sizes.

### TECHNICAL FIELD

The present application relates generally to sockets for driving fasteners, and in particular to sockets and sets of sockets having markings that identify a size and/or type of the respective sockets.

### BACKGROUND

A variety of wrenches and tools are commonly used to apply torque to a workpiece, such as a threaded fastener. The workpiece may be any number of different sizes and shapes and fitments. Accordingly, many tools include a driver adapted to mate with one or more different adapters, such as sockets, to engage and rotate the different workpieces. Sockets are typically used for driving hexagonal nuts or boltheads. The appropriately sized socket must be selected for each sized nut or bolthead. Sockets may be S.A.E. sized (also known as imperial or English) or metric. For example, a ½ inch socket is provided for a ½ inch diameter nut. Similarly, for metric sized nuts, a 10 mm socket is provided for a nut having a 10 mm diameter.

It is common for sockets to be sold in sets that contain a number of sockets of various respective sizes. The sets may include metric and/or S.A.E. sized sockets. Socket sets are commonly sold together with a socket carrier for storing and organizing the sockets, and the sockets are typically arranged in order based on the socket size, as well as grouped with other SAE or metric sockets. The sizes of the respective sockets is typically displayed on the outer surface of the socket to allow for identifying the desired socket for work, and for returning the socket to the corresponding position in the socket carrier upon completion of work. However, visual identification of sockets may be time consuming or difficult, particularly for sockets that are close in size and when the sockets are not well-labeled. Also, sizes are often stamped or laser-etched onto the socket, which is often difficult to read, especially in low light conditions. It is also common for metric and imperial sockets to become mixed, causing confusion and requiring additional time to locate the desired socket.

### SUMMARY

The present invention relates broadly to sockets and socket sets that include markings on the respective sockets for indicating socket size and distinguishing variously sized sockets from one another. The markings on a socket may include multiple numeric indicia on the outer surface of the socket in combination with one or more lines between the numeric indicia, where the number of lines is different between sockets that are adjacent sizes, thereby further distinguishing the sockets. The alternating appearance of sockets adjacent in size allows for quicker and easier identification of the appropriate socket, saving time and reducing the chance of error.

In an embodiment, the present invention relates broadly to a set of sockets including first and second sockets respectively having first and second sizes, each of the first and second sockets includes a driving portion, a work portion, an outer surface, and first and second numerical indicia disposed on the outer surface. The first socket includes a first line disposed on the outer surface of the first socket and between the first and second numerical indicia.

In another embodiment, the present invention relates broadly to a set of sockets including first and second sockets respectively having first and second sizes, each of the first and second sockets includes an outer surface, a drive portion having a drive end, a work piece engaging end, and first and second numerical indicia disposed on the outer surface. The first socket includes a first line disposed on the outer surface of the first socket and between the drive end and the first and second numerical indicia, or between the work piece engaging end and the first and second numerical indicia.

### BRIEF DESCRIPTION OF THE DRAWINGS

Embodiments of devices and methods are illustrated in the figures of the accompanying drawings which are meant to be exemplary and not limiting, in which like references are intended to refer to like or corresponding parts, and in which:

FIG. 1 is a side plan view of a first group of exemplary sockets, according to an embodiment of the present invention.

FIG. 2 is a side plan view of a first exemplary socket of the first group of exemplary sockets of FIG. 1, according to an embodiment of the present invention.

FIG. 3 is a top plan view of the first exemplary socket of FIG. 2, according to an embodiment of the present invention.

FIG. 4 is a top plan view of the first exemplary socket of FIG. 2, according to another embodiment of the present invention.

FIG. 5 is a bottom plan view of the first exemplary socket of FIG. 2, according to an embodiment of the present invention.

FIG. 6 is a bottom plan view of the first exemplary socket of FIG. 2, according to another embodiment of the present invention.

FIG. 7 is a bottom plan view of the first exemplary socket of FIG. 2, according to another embodiment of the present invention.

FIG. 8 is a side plan view of a second exemplary socket of the first group of exemplary sockets of FIG. 1, according to an embodiment of the present invention.

FIG. 9 is a side plan view of a second group of sockets, according to an embodiment of the present invention.

FIG. 10A is a front side plan view of a first exemplary socket of the second group of sockets, according to an embodiment of the present invention.

FIG. 10B is a back side plan view of the first exemplary socket of FIG. 10A, according to an embodiment of the present invention.

FIG. 11 is a side plan view of a second exemplary socket of the second group of sockets, according to an embodiment of the present invention.

FIG. 12 is a side plan view of a third group of sockets, according to an embodiment of the present invention.

FIG. 13 is a side plan view of a first exemplary socket of the third group of sockets, according to an embodiment of the present invention.

FIG. 14 is a side plan view of a fourth group of sockets, according to an embodiment of the present invention.

FIG. 15A is a front side plan view of a first exemplary socket of the fourth group of sockets, according to an embodiment of the present invention.

FIG. 15B is a back side plan view of the first exemplary socket of FIG. 15A, according to an embodiment of the present invention.

FIG. 16 is a side plan view of a fifth group of sockets, according to an embodiment of the present invention.

FIG. 17A is a side plan view of a first exemplary socket of the fifth group of sockets, according to an embodiment of the present invention.

FIG. 17B is a side plan view of a second exemplary socket of the fifth group of sockets, according to an embodiment of the present invention.

FIG. 18 is a side plan view of a sixth group of sockets, according to an embodiment of the present invention.

FIG. 19 is a side plan view of a first exemplary socket of the sixth group of sockets, according to an embodiment of the present invention.

FIG. 20 is a side plan view of a seventh group of sockets, according to an embodiment of the present invention.

FIG. 21 is a side plan view of a eighth group of sockets, according to an embodiment of the present invention.

FIG. 22 is a side plan view of a ninth group of sockets, according to an embodiment of the present invention.

FIG. 23 is a side plan view of a tenth group of sockets, according to an embodiment of the present invention.

### DETAILED DESCRIPTION

Detailed embodiments of devices and methods are disclosed herein. However, it is to be understood that the disclosed embodiments are merely exemplary of the devices and methods, which may be embodied in various forms. Therefore, specific functional details disclosed herein are not to be interpreted as limiting, but merely as a basis for the claims and as a representative example for teaching one skilled in the art to variously employ the present disclosure.

The present invention relates broadly to sockets adapted to engage a head of a fastener, such as a polygonal nut or bolt (also referred to herein as a fastener head). The sockets each include markings for indicating the socket size and distinguishing variously sized sockets from one another. The markings on the socket may include multiple numerical indicia on the outer surface and/or one or more lines on the outer surface of some of the sockets in a socket set. In an embodiment, the one or more lines are present on sockets of alternating sizes. The inclusion of multiple numerical indicia and one or more lines provides easier socket identification.

In an embodiment, the sockets are adapted to mate with lugged wrenches, such as, for example, a ratchet wrench, torque wrench, or breaker bar. In general, the sockets each includes a body having first and second ends and an outer surface. The first and second ends may have outer diameters that are substantially circular, and the outer surface may be substantially cylindrical, and extend between the first and second ends. The outer surface may include protrusions or indents along the surface. The outer surface of the socket may also include a raised portion, and numerical indicia and/or a line or lines may be disposed on the raised portion of the outer surface. The raised portion may allow for easier handling by a user and provide a larger surface upon which the numerical indicia and/or the lines may be disposed. The raised portion may provide tactile feedback to a user for identifying the socket (similar to Braille). For example, when the sockets are metric sized, the even sized sockets (e.g., 10, 20, 30 mm) may include a raised portion, and the sockets that are odd sized (e.g., 9, 19, 29 mm) may not include a raised portion.

The first end includes a first axial bore, defining a drive portion. The drive portion may have a substantially square cross-sectional shape extending at least partially into the body from the first end towards the second end. The drive portion is adapted to matingly engage a drive shaft or drive lug of a tool, for example, a hand tool, a socket wrench or ratchet wrench, a torque wrench, an impact driver, an impact wrench, and other tools, in a well-known manner. The squared cross-sectional shape may be, for example, about a ¼, ⅜, ½, or ¾ inch square, or other S.A.E. or metric sizes. In yet another embodiment, the drive portion may be formed to have different cross-sectional shapes adapted to mate with differently shaped tools, for example, the cross-sectional shape may be triangular, rectangular, pentagonal, hexagonal, heptagonal, octagonal, or other shapes of the type.

The second end includes a second axial bore, defining a work portion. The work portion may have a polygonal cross-sectional shape axially extending at least partially into the body from the second end towards the first end. In an embodiment, the polygonal cross-sectional shape is a generally hexagonal shape adapted to engage the fastener head, such as a hexagonal bolt head or nut. In yet another embodiment, the work portion may be formed to have different cross-sectional shapes adapted to mate with different shaped fastener heads, for example, triangular, rectangular, pentagonal, heptagonal, octagonal, hex shaped, double hexagonal, spline or other shapes of the type.

The sizes and dimensions of the various elements of the sockets described herein may be modified or adapted for a particular use with one or more different tools. For example, the work portion of the respective sockets may be adapted to receive different fastener sizes, for example, 1 inch, ½ inch, 10 mm, 12 mm, 14 mm, etc., as well known in the art. Similarly, the size of the drive portion can be adapted to receive different sizes and types of drive shafts or drive lugs of tools.

The numerical indicia may indicate the size of the socket using a number, for example in metric sizes, such as 1 to 100 mm, including 1, 2, 3, 4, 5, 6, mm, etc. Alternatively, the numerical indicia may indicate the S.A.E. size of the socket, such as ⅛ to 3 inches, including ¼, 3/16, ⅛, 5/16, ⅜, 7/16, ½, inches, etc. The numerical indicia is preferably oriented so at least a bottom of the number is parallel with the first and second ends. The height of the numerical indicia may be selected to have numbers of a size that would be identifiable by a user.

The numerical indicia may be flat, raised, or recessed (such as via etching or stamping) into the surface of the sockets to provide distinctive appearances or to provide tactile feedback. For example, the numerical indicia may be raised on even numbered metric sockets and flat or etched on odd numbered metric sockets, or vice versa. The numerical indicia may further be colored, such as a color that is different than a color of the outer surface of the socket (e.g., if the outer surface is chrome or bright metallic, the indicia may be red). The colors of the numerical indicia may also be different on sockets that are different sizes. For example, the color of the numerical indicia may alternate for sockets of alternating sizes. For example, when the sockets are metric sized, the even sized sockets (e.g., 10, 20, 30 mm) may be a first color (e.g., red), and the sockets that are odd sized (e.g., 9, 19, 29 mm) may be a second color (e.g., blue). Additional numerical indicia may also be disposed on the outer surface of the socket. The number of numerical indica on each socket may be 2, 3, 4, 5, 6, 7, or 8. In an embodiment, there are at least two or three numerical indicia on a socket. The numerical indicia may be spaced substantially equidistantly apart from each other circumferentially on the outer surface. For example, two numerical indicia may be spaced about 180 degrees apart, three numerical indica may be spaced about 120 degrees away from each other, and four numerical indicia may be spaced about 90 degrees away from each other. The number of numerical indicia may also be different on different sized sockets. For example, even numbered metric sockets may have two numerical indica, while odd numbered metric sockets may have three numerical indicia. The numerical indica are disposed on the outer surface of the sockets between the drive end and the work end. Each numerical indicium on a socket may be substantially equidistant from the drive end. Alternatively, the numerical indicia may be different distances away from the drive end. In another embodiment, the numerical indicia on a first socket may be proximal to the work end, while the numerical indicia on a second socket that is adjacent in size are positioned proximal to the drive end.

The lines on the outer surface may be substantially between the numerical indicia. In an embodiment, one line is disposed between the numerical indicia, and the line is substantially between the top and bottom of the numerical indicia. When multiple lines are disposed on a socket, the area between the numerical indicia may define an area having a height that is substantially equal to the height of the numerical indicia. A first line may be disposed in this area, proximal to the drive end, and a second line may be disposed in this area, proximal to the work end. Additional lines may also be present in this area. The number of lines may be, for example, 0 to 20, particularly 0, 1, 2, 3, 4, 5, 6, 7, or 8, and more particularly 0, 1 or 2. The lines may be flat, raised or recessed, relative to the outer surface of the socket, to provide tactile feedback as well. The lines may also have a color that is different than the color of the socket. For example, when the sockets are metric sized, the lines on the even sized sockets (e.g., 10, 20, 30 mm) may be a first color (e.g., red), and the lines on the sockets that are odd sized (e.g., 9, 19, 29 mm) may be a second color (e.g., blue). The lines may be solid lines, dashed lines, or a line that is a combination of straight and dashed portions.

In another embodiment, the line or lines may be circumferentially disposed on the outer surface, between the top of the numerical indicia and the drive end. Alternatively, the line or lines may be disposed between the work end and the numerical indicia.

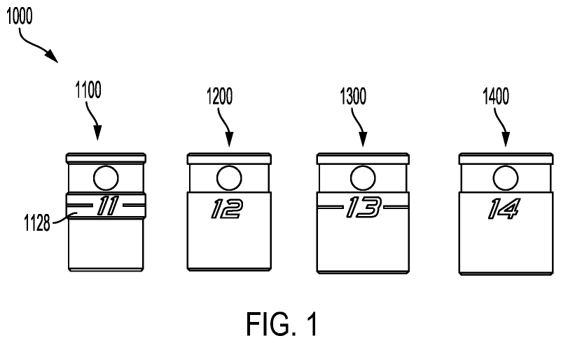

Referring to FIG. 1, a first group of sockets 1000 of a first set of exemplary sockets is shown. The first group of sockets 1000 may include sockets 1100, 1200, 1300, and 1400. As shown, the first group of sockets 1000 is a group of metric sockets, where socket 1100 is a 11 mm socket, socket 1200 is a 12 mm socket, socket 1300 is a 13 mm socket, and socket 1400 is a 14 mm socket. It will be appreciated that the sockets can be any respective sizes. It will further be appreciated that while four sockets are shown, the first group of sockets 1000 and/or first set of sockets may include more or less than four sockets, and four sockets are shown for exemplary purposes only.

Each of the sockets 1100-1400 in the first group of sockets 1000 includes two numerical indicia disposed about 180 degrees apart. The odd sized sockets, such as the sockets 1100 and 1300 (e.g., 11 and 13 mm), also include lines that extend partially circumferentially around the respective sockets between the two numerical indicia. The inclusion of numerical indicia on all of the sockets, and one or more lines on the odd sized sockets, reduces the risk of misidentifying sockets of adjacent sizes, such as a 11 mm socket and a 12 mm socket.

Referring to FIG. 2, an exemplary socket, such as socket 1300 of the first group of sockets 1000, is shown and described. It will be appreciated that each of the sockets 1100-1400 may include similar features. For example, socket 1300 has an outer surface 1302, a drive end 1304, and a work end 1306. A first numerical indicia 1308 is disposed on the outer surface 1302. While FIG. 2 shows a front view of the socket 1300, it will be understood that the back view of the socket may be substantially identical, and the back view includes a second numerical indicia substantially the same as the first numerical 1308. In this embodiment, the first and second numerical indicia are disposed about 180 degrees apart. First and second lines 1314, 1316 are also disposed on the outer surface 1302, and extends partially circumferentially around the socket between the first and second numerical indicia.

Further, as shown, the first numerical indicia 1308 includes first and second numerals 1310, 1312. However, it will be appreciated that the numerical indicia may include less than two numerals (such as a single numeral) or more than two numerals corresponding to a size of the socket.

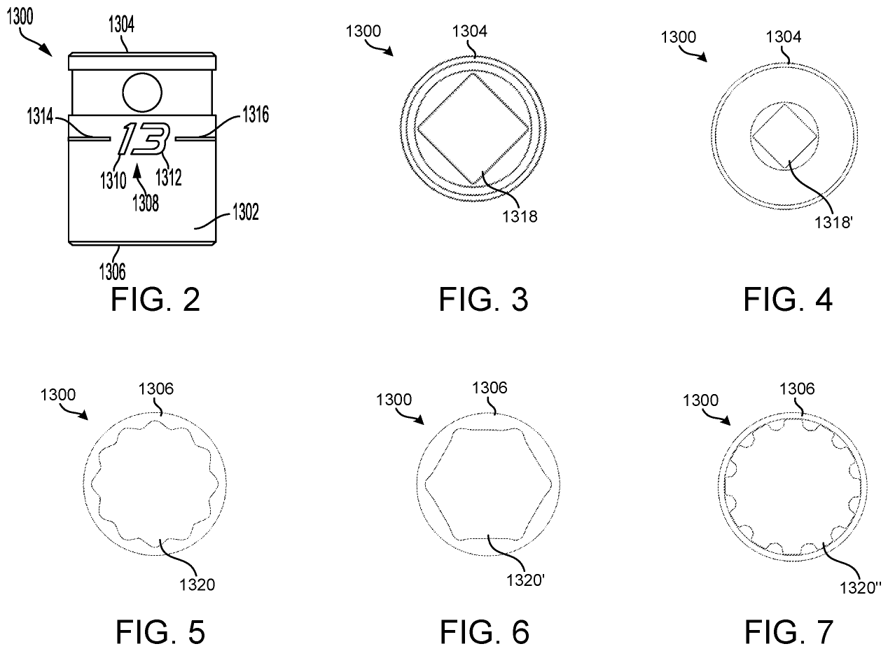

Referring to FIGS. 3-7, the socket 1300 has a drive portion 1318 or 1318′ defined in the drive end 1304, and a work portion 1320, 1320′, or 1320″ defined in the work end 1306 opposite the drive end 1304. The drive portions 1318 and 1318′ may have a substantially square cross-sectional shape of differing sizes. The work portions 1320, 1320′, and 1320″ may also have different shapes. For example, the work portion 1320 may have a dodecagonal shape, the work portion 1320′ may have a hexagonal shape, and the work portion 1320″ may have a splined shape. It will be appreciated that the work portion may have any other cross-sectional shape adapted to mate with different shaped fastener heads.

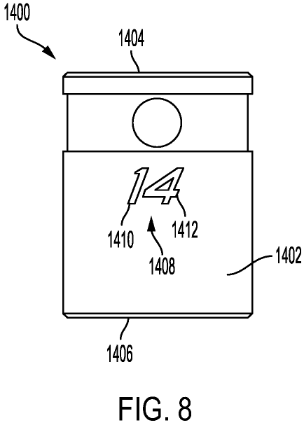

FIG. 8 illustrates a second socket that is an adjacent size to the socket 1300, such as the socket 1400. The socket of FIG. 8 is an even numbered size and does not include a line between the numerical indicia. However, the socket 1400 may include similar features to that of the socket 1300. For example, the socket 1400 has an outer surface 1402, a drive end 1404, and a work end 1406. A first numerical indicia 1408 of first and second numerals 1410, 1412 are disposed on the outer surface 1402. While FIG. 8 shows a front view of the socket 1400, it is understood that the back view of the socket may be substantially identical, and the back view includes a second numerical indicia substantially the same as the first numerical 1408. In this embodiment, the first and second numerical indicia are disposed about 180 degrees apart. Further, as shown, the first numerical indicia 1408 includes first and second numerals 1410, 1412. However, it will be appreciated that the numerical indicia may include less than two numerals (such as a single numeral) or more than two numerals corresponding to a size of the socket.

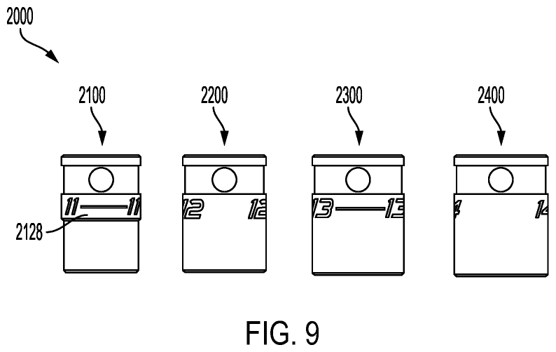

Referring to FIG. 9, a second group of sockets 2000 of a second set of exemplary sockets is shown. The second group of sockets 2000 may include sockets 2100, 2200, 2300, and 2400. As shown, the second group of sockets 2000 is a group of metric sockets, where socket 2100 is a 11 mm socket, socket 2200 is a 12 mm socket, socket 2300 is a 13 mm socket, and socket 2400 is a 14 mm socket. Further, it will be appreciated that while four sockets are shown for exemplary purposes, the second group of sockets 2000 and/or second set of sockets may include more or less than four sockets.

Each of sockets 2100-2400 in the second group of sockets 2000 includes three numerical indicia disposed 120 degrees apart. The odd sized sockets, such as the sockets 2100 and 2300, also include lines that extend partially circumferentially around the respective sockets between the adjacent ones of the numerical indicia. The inclusion of numerical indicia on all of the sockets, and one or more lines on the odd sized sockets reduces the risk of misidentifying sockets of adjacent sizes, such as an 11 mm socket and a 12 mm socket.

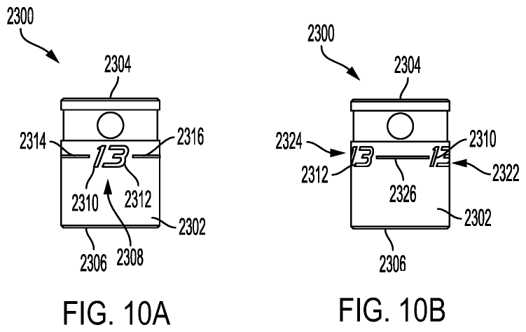

Referring to FIGS. 10A and 10B, a front view and a back view of an exemplary socket, such as socket 2300 of the second group of sockets 2000 is shown and described. It will be appreciated that each of the sockets 2100-2400 may include similar features. For example, socket 2300 has an outer surface 2302, a drive end 2304 (similar to drive end 1304 described above), and a work end 2306 (similar to drive end 1306 described above). First, second, and third numerical indicia 2308, 2322, and 2324 are disposed on the outer surface 1302. In this embodiment, the first, second, and third numerical indicia 2308, 2322, and 2324 are disposed about 120 degrees apart. A first line 2314 is also disposed on the outer surface 2302 and extends partially circumferentially around the socket between the first and second numerical indicia 2308 and 2322. A second line 2316 is also disposed on the outer surface 2302 and extends partially circumferentially around the socket between the first and third numerical indicia 2308 and 2324. Similarly, a third line 2326 is disposed on the outer surface 2302 and extends partially circumferentially around the socket between the second and third numerical indicia 2322 and 2324. Further, as shown, each of the first, second, and third numerical indicia 2308, 2322, and 2324 includes first and second numerals 2310, 2312. However, it will be appreciated that the numerical indicia may include less than two numerals (such as a single numeral) or more than two numerals corresponding to a size of the socket.

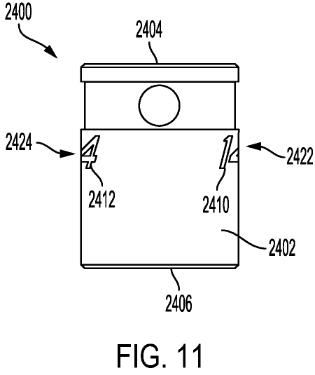

FIG. 11 illustrates a second socket that is an adjacent size to the socket 2300, such as socket 2400. As shown, the socket of FIG. 11 is an even numbered size and does not include lines between the numerical indicia. However, the socket 2400 may include similar features to that of the socket 2300. For example, the socket 2400 has an outer surface 2402, a drive end 2404, and a work end 2406. The socket 2400 also includes first, second, and third numerical indicia that are disposed about 120 degrees apart. As shown, the second and third numerical indicia 2422 and 2424 are disposed on the outer surface 2402. While FIG. 11 shows a back view of socket 2400, it will be understood that the front view of the socket includes the first numerical indicia similar to that of the socket 2300. Further, as shown, each of the first, second, and third numerical indicia includes first and second numerals 2410, 2412. However, it will also be appreciated that the numerical indicia may include less than two numerals (such as a single numeral) or more than two numerals corresponding to a size of the socket.

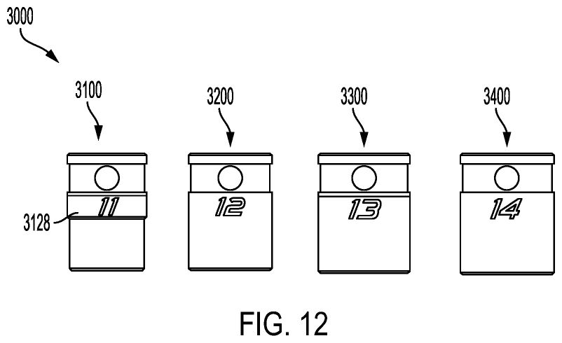

Referring to FIG. 12, a third group of exemplary sockets 3000 of a third set of sockets is shown. The third group of sockets 3000 may include sockets 3100, 3200, 3300, and 3400. As shown, the third group of sockets 3000 is a group of metric sockets, where socket 3100 is an 11 mm socket, socket 3200 is a 12 mm socket, socket 3300 is a 13 mm socket, and socket 3400 is a 14 mm socket. Further, while four sockets are shown for exemplary purposes, the third group of sockets 3000 and/or third set of sockets may include more or less than four sockets.

Each of the sockets 3100-3400 in the third group of sockets 3000 includes two numerical indicia disposed 180 degrees apart. The odd sized sockets, such as the sockets 3100 and 3300, also include one or more lines that extend circumferentially around the socket above the numerical indicia and/or proximal to a drive end of the socket. The inclusion of numerical indicia on all of the sockets, and one or more lines on the odd sized sockets reduces the risk of misidentifying sockets of adjacent sizes, such as an 11 mm socket and a 12 mm socket.

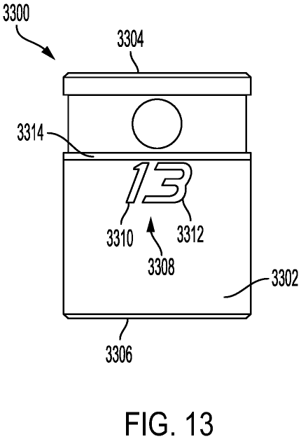

Referring to FIG. 13, an exemplary socket, such as socket 3300, of the third group of sockets 3000 is shown and described. It will be appreciated that each of the sockets 3100-3400 may include similar features. For example, socket 3300 has an outer surface 3302, a drive end 3304 (similar to drive end 1306 described above), and a work end 3306 (similar to drive end 1306 described above). A first numerical indicia 3308 is disposed on the outer surface 3302. While FIG. 13 shows a front view of the socket 3300, it will be understood that the back view of the socket may be substantially identical, and the back view includes a second numerical indicia. In this embodiment, the first and second numerical indicia are disposed about 180 degrees apart. A first line 3314 is also disposed on the outer surface 3302 and extends circumferentially around the socket above the numerical indicia and/or proximal to a drive end 3304. In other words, the first line 3314 is disposed between the drive end 3304 and the first and second numerical indicia. In another embodiment, the first line may be disposed below the numerical indicia and/or proximal to a work end 3306. In other words, the first line may be disposed between the work end 3306 and the first and second numerical indicia.

Further, as shown, the first numerical indicia 3308 includes first and second numerals 3310, 3312. However, it will be appreciated that the numerical indicia may include less than two numerals (such as a single numeral) or more than two numerals corresponding to a size of the socket.

Each of the even sized sockets in the third group of sockets 3000 also includes two numerical indicia disposed about 180 degrees apart. However, each of the even sized sockets, such as sockets 3200 and 3400, does not include lines that extend circumferentially around the socket above the numerical indicia and/or proximal to a drive end of the socket.

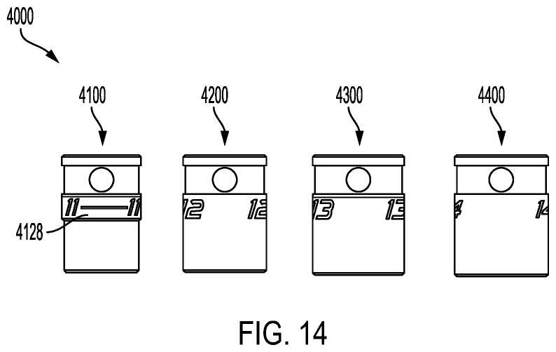

Referring to FIG. 14, a fourth group of exemplary sockets 4000 of a fourth set of sockets is shown. The fourth group of sockets 4000 may include sockets 4100, 4200, 4300, and 4400. As shown, the fourth group of sockets 4000 is a group of metric sockets, where socket 4100 is a 11 mm socket, socket 4200 is a 12 mm socket, socket 4300 is a 13 mm socket, and socket 4400 is a 14 mm socket. Further, while four sockets are shown for exemplary purposes, the fourth group of sockets 4000 and/or fourth set of sockets may include more or less than four sockets.

Each of sockets 4100-4400 in the fourth group of sockets 4000 includes three numerical indicia disposed 120 degrees apart. The odd sized sockets, such as the sockets 4100 and 4300, also include one or more lines that extend circumferentially around the socket above the numerical indicia and/or proximal to a drive end of the socket. The inclusion of numerical indicia on all of the sockets, and one or more lines on the odd sized sockets reduces the risk of misidentifying sockets of adjacent sizes, such as an 11 mm socket and a 12 mm socket.

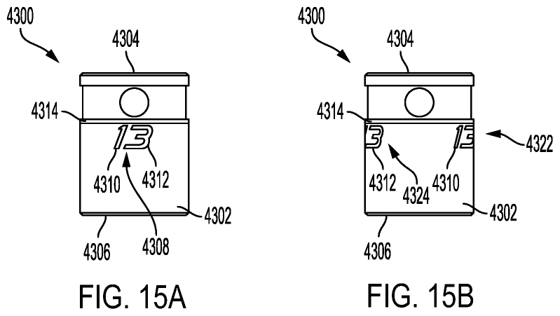

Referring to FIGS. 15A and 15B a front view and back view of an exemplary socket, such as socket 4300, of the fourth group of sockets 4000 is shown and described. It will be appreciated that each of the sockets 4100-4400 may include similar features. For example, the socket 4300 has an outer surface 4302, a drive end 4304 (similar to drive end 1304 described above), and a work end 4306 (similar to drive end 1306 described above). First, second, and third numerical indicia 4308, 4322, and 4324 are disposed on the outer surface 4302. In this embodiment, the first, second, and third numerical indicia 4308, 4322, and 4324 are disposed about 120 degrees apart. A first line 4314 is also disposed on the outer surface 4302 and extends circumferentially around the socket above the numerical indicia and/or proximal to a drive end 4304. In other words, the first line 4314 is disposed between the drive end 4304 and the first, second, and third numerical indicia. In another embodiment, the first line may be disposed below the numerical indicia and/or proximal to a work end 4306. In other words, the first line may be disposed between the work end 4306 and the first, second, and third numerical indicia.

Further, as shown, the first numerical indicia 4308 includes first and second numerals 4310, 4312. However, it will be appreciated that the numerical indicia may include less than two numerals (such as a single numeral) or more than two numerals corresponding to a size of the socket.

Each of the even sized sockets in the third group of sockets 4000 also includes three numerical indicia disposed 120 degrees apart. However, each of the even sized sockets, such as the sockets 4200 and 4400, does not include lines that extend circumferentially around the socket above the numerical indicia and/or proximal to a drive end of the socket.

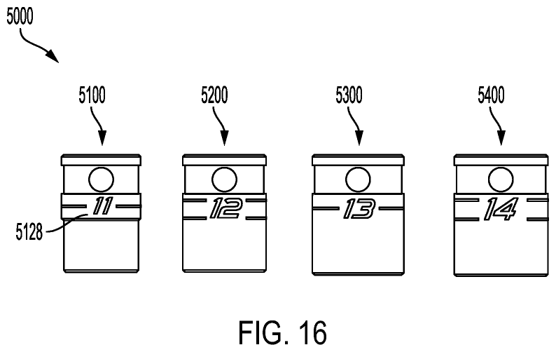

Referring to FIG. 16, a fifth group of exemplary sockets 5000 of a fifth set of sockets is shown. The fifth group of sockets 5000 may include sockets 5100, 5200, 5300, and 5400. The fifth group of sockets 5000 may include sockets 5100, 5200, 5300, and 5400. As shown, the fifth group of sockets 5000 is a group of metric sockets, where socket 5100 is a 11 mm socket, socket 5200 is a 12 mm socket, socket 5300 is a 13 mm socket, and socket 5400 is a 14 mm socket. Further, while four sockets are shown for exemplary purposes, the fifth group of sockets 5000 and/or fifth set of sockets may include more or less than four sockets.

Each of the sockets 5100-5400 in the fifth group of sockets 5000 includes two numerical indicia disposed 180 degrees apart. The odd sized sockets, such as the sockets 5100 and 5300, also include single lines that extend partially circumferentially around the respective sockets between the two numerical indicia. The even sized sockets, such as the sockets 5200 and 5400, include double lines that extend partially circumferentially around the respective sockets between the two numerical indicia. The inclusion of numerical indicia on all of the sockets, and the single lines on the odd sized sockets and the double-lines on the even sized sockets reduces the risk of misidentifying sockets of adjacent sizes, such as an 11 mm socket and a 12 mm socket.

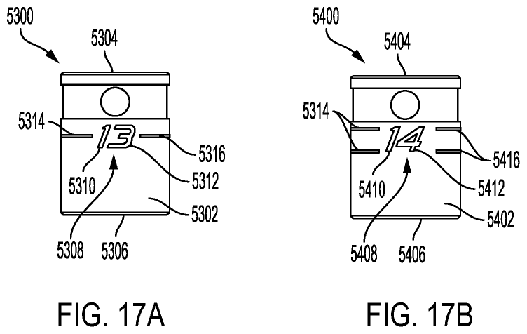

Referring to FIG. 17A, an exemplary socket, such as such as socket 5300, of the fifth group of sockets 5000 is shown and described. It will be appreciated that each of the sockets 5100-5400 may include similar features. In this embodiment, the socket 5300 is substantially the same as the socket 1300. For example, socket 5300 has an outer surface 5302, a drive end 5304 (similar to drive end 1304 described above), and a work end 5306 (similar to drive end 1306 described above). A first numerical indicia 5308 is disposed on the outer surface 5302. While FIG. 17A shows a front view of socket 5300, it will be understood that the back view of the socket may be substantially identical, and the back view includes a second numerical indicia. In this embodiment, the first and second numerical indicia are disposed about 180 degrees apart. First and second lines 5314 and 5316 are also disposed on the outer surface 5302, and each extends partially circumferentially around the socket between the first and second numerical indicia.

Further, as shown, the first numerical indicia 5308 includes first and second numerals 5310, 5312. However, it should be appreciated that the numerical indicia may include less than two numerals (such as a single numeral) or more than two numerals corresponding to a size of the socket.

FIG. 17B illustrates an exemplary second socket 5400 of the fifth set of sockets 5000. The socket 5400 also has an outer surface 5402, a drive end 5404 (similar to drive end 1304 described above), and a work end 5406 (similar to drive end 1306 described above). A first numerical indicia 5408 is disposed on the outer surface 5402. While FIG. 17B shows a front view of the socket 5400, it is understood that the back view of the socket is substantially identical, and the back view includes a second numerical indicia. In this embodiment, a first pair of lines 5414 and a second pair of lines 5416 are disposed on the outer surface 5402, and each pair of lines extends partially circumferentially around the socket between the first and second numerical indicia.

Further, as shown, the first numerical indicia 5408 includes first and second numerals 5410, 5412. However, it will be appreciated that the numerical indicia may include less than two numerals (such as a single numeral) or more than two numerals corresponding to a size of the socket.

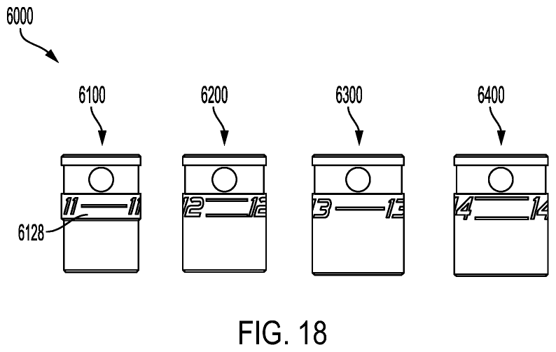

Referring to FIG. 18, a sixth group of exemplary sockets 6000 of a sixth set of sockets is shown. The sixth group of sockets 6000 may include sockets 6100, 6200, 6300, and 6400. As shown, the sixth group of sockets 6000 is a group of metric sockets, where socket 6100 is a 11 mm socket, socket 6200 is a 12 mm socket, socket 6300 is a 13 mm socket, and socket 6400 is a 14 mm socket. Further, while four sockets are shown for exemplary purposes, the sixth group of sockets 6000 and/or sixth set of sockets may include more or less than four sockets.

Each of the sockets 6100-6400 in the sixth group of sockets 6000 includes three numerical indicia disposed about 120 degrees apart. The odd sized sockets, such as the sockets 6100 and 6300, are substantially the same as the odd size sockets described with reference to the second group of sockets 2000. For example, in this embodiment, the socket 6300 is substantially the same as the socket 2300 and includes single lines that extend partially circumferentially around the respective sockets between the adjacent ones of the numerical indicia.

The even sized sockets, such as the sockets 6200 and 6400, include double-lines that extend partially circumferentially around the respective sockets between adjacent ones of the numerical indicia. The inclusion of numerical indicia on all of the sockets, and the single lines on the odd sized sockets and the double-lines on the even sized sockets reduces the risk of misidentifying sockets of adjacent sizes, such as a 11 mm socket and a 12 mm socket.

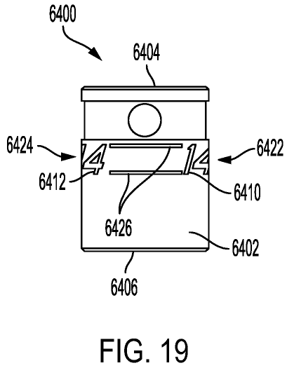

FIG. 19 illustrates an even sized exemplary socket 6400 of the sixth set of sockets 6000. The socket 6400 is similar to the socket 2300 described above, except that the socket 6400 includes double lines instead of single lines between the numerical indicia. For example, socket 6400 has an outer surface 6402, a drive end 6404 (similar to drive end 1304 described above), and a work end 6406 (similar to drive end 1306 described above). First, second, and third numerical indicia are disposed on the outer surface 6402 about 120 degrees apart. First, second, and third pairs of lines are also disposed on the outer surface 6402, and each extends partially circumferentially around the socket between adjacent numerical indicia. For example, as shown in FIG. 19, a third pair of lines 6426 is disposed on the outer surface 6402 and extends partially circumferentially around the socket between second and third numerical indicia 6422 and 6424. Further, each of the first, second, and third numerical indicia includes first and second numerals 6410, 6412. However, it will be appreciated that the numerical indicia may include less than two numerals (such as a single numeral) or more than two numerals corresponding to a size of the socket.

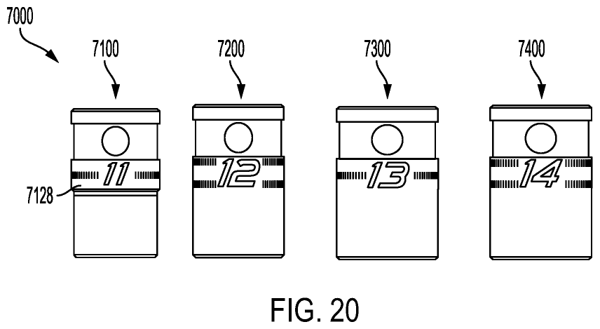

Referring to FIG. 20, a seventh group of exemplary sockets 7000 of a seventh set of sockets is shown. The seventh group of sockets 7000 may include sockets 7100, 7200, 7300, and 7400. The seventh group of sockets 7000 are substantially the same as those of the fifth group of sockets 5000, except that the lines between the numerical indicia are dashed lines.

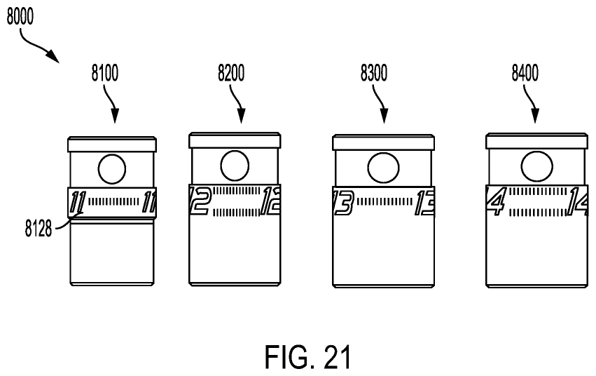

Referring to FIG. 21, an eighth group of exemplary sockets 8000 of a eighth set of sockets is shown. The eighth group of sockets 8000 may include sockets 8100, 8200, 8300, and 8400. The eighth group of sockets 8000 are substantially the same as those of the sixth group of sockets 6000, except that the lines between the numerical indicia are dashed lines.

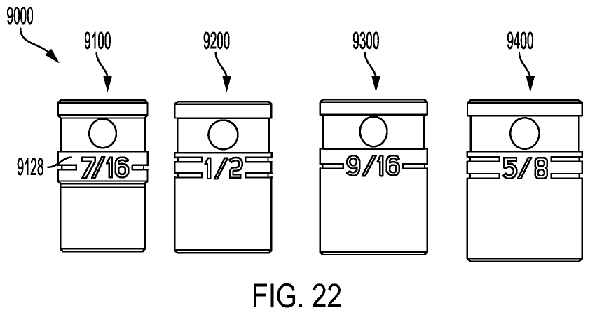

Referring to FIG. 22, a ninth group of exemplary sockets 9000 of a ninth set of sockets is shown. The ninth group of sockets 9000 may include sockets 9100, 9200, 9300, and 9400. As shown, the ninth group of sockets 9000 is a group of SAE sockets, where socket 9100 is 7/16 inch socket, socket 9200 is a ½ inch socket, socket 9300 is a 9/16 inch socket, and socket 9400 is a ⅝ inch socket. Further, while four sockets are shown, the ninth group of sockets 9000 and/or ninth set of sockets may include more or less than four sockets.

The ninth group of sockets 9000 is substantially similar to the fifth group of sockets 5000, with the sockets with 1/16 inch designations of the ninth group of sockets 9000 having similar features as the odd sized sockets of the fifth group of sockets 5000. For example, each of the sockets 9100-9400 in the ninth group of sockets 9000 may include two numerical indicia disposed 180 degrees apart. The 1/16 inch sized sockets, such as the sockets 9100 and 9300, also include single lines that extend partially circumferentially around the respective sockets between the two numerical indicia. The non- 1/16 inch sized sockets, such as the sockets 9200 and 9400, include double lines that extend partially circumferentially around the respective sockets between the two numerical indicia.

In another embodiment, the ninth group of sockets 9000 may be substantially similar to the seventh group of sockets 7000, with the sockets with 1/16 inch designations of the ninth group of sockets 9000 having similar features as the odd sized sockets of the seventh group of sockets 7000. For example, the lines between the numerical indicia of the ninth group of sockets 9000 may be dashed lines

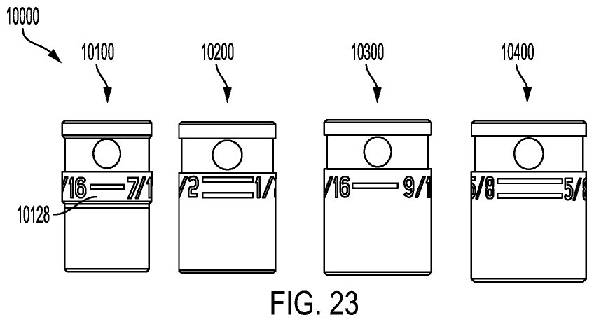

Referring to FIG. 23, a tenth group of sockets 10000 of a tenth set of sockets is shown. The tenth group of sockets 10000 may include sockets 10100, 10200, 10300, and 10400. As shown, the tenth group of sockets 10000 is a group of SAE sockets, where socket 10100 is 7/16 inch socket, socket 10200 is a ½ inch socket, socket 10300 is a 9/16 inch socket, and socket 10400 is a ⅝ inch socket. Further, while four sockets are shown, the tenth group of sockets 10000 and/or tenth set of sockets may include more or less than four sockets.

The tenth group of sockets 10000 is substantially similar to the sixth group of sockets 6000, with the sockets with 1/16 inch designations of the tenth group of sockets 10000 having similar features as the odd sized sockets of the sixth group of sockets 6000. For example, each of the sockets 10100-10400 in the tenth group of sockets 10000 includes three numerical indicia disposed 120 degrees apart. The 1/16 inch sized sockets, such as the sockets 10100 and 10300, also include single lines that extend partially circumferentially around the respective sockets between the two numerical indicia. The non- 1/16 inch sized sockets, such as the sockets 10200 and 10400, include double lines that extend partially circumferentially around the respective sockets between the two numerical indicia.

In another embodiment, the tenth group of sockets 10000 may be substantially similar to the eighth group of sockets 8000, with the sockets with 1/16 inch designations of the tenth group of sockets 10000 having similar features as the odd sized sockets of the eighth group of sockets 8000. For example, the lines between the numerical indicia of the tenth group of sockets 10000 may be dashed lines.

Any of the sockets may also include a raised portion on the outer surface extending circumferentially around of the socket, and the numerical indicia and/or lines may be disposed on the raised portion. For example, sockets 1100, 2100, 3100, 4100, 5100, 6100, 7100, 8100, 9100, 10100 are illustrated as including respective raised portions 1128, 2128, 3128, 4128, 5128, 6128, 7128, 8128, 9128, 10128 on the outer surface of the respective sockets and extending circumferentially around of the respective sockets, and the numerical indicia and/or lines may be disposed on the raised portion. The raised portion may provide tactile feedback to a user for identifying the socket (similar to Braille). The raised portion may allow for easier handling by a user and provide a larger surface upon which the numerical indicia and/or the line may be disposed. It should be appreciated that any of the sockets disposed herein may include a raised portion. Further, a set of sockets may include raised portions on even-sized sockets to aid in distinguishing the even-sized sockets from the odd-sized sockets in the set of sockets, or vice versa.

It will be appreciated that any of the sockets described herein may include a drive portion similar to the drive portions 1318 or 1318′ described above in connection with socket 1300, and a work portion similar to the work portions 1320, 1320′, or 1320″ described above in connection with socket 1300. For example, the work portion of any of the sockets described herein may have a dodecagonal shape, hexagonal shape, splined shape or any other cross-sectional shape adapted to mate with different shaped fastener heads.

It should also be appreciated that in any of the embodiments, the numerical indica on a socket may be changed to an even or odd number, or metric or S.A.E. size without departing from the spirit of the invention.

Although the devices and methods have been described and illustrated in connection with certain embodiments, many variations and modifications will be evident to those skilled in the art and may be made without departing from the spirit and scope of the present disclosure. The present disclosure is thus not to be limited to the precise details of methodology or construction set forth above as such variations and modification are intended to be included within the scope of the present disclosure. Moreover, unless specifically stated any use of the terms first, second, etc. do not denote any order or importance, but rather the terms first, second, etc. are merely used to distinguish one element from another.

What is claimed is:

1. First and second sockets respectively having first and second sizes, each of the first and second sockets having a driving portion, a work portion, and an outer surface, the first and second sockets comprising:
first and second numerical indicia respectively disposed on the outer surfaces of the first and second sockets to respectively identify the first and second sizes, wherein the first socket includes a first line disposed on the outer surface of the first socket and between the first and second numerical indicia.

2. The first and second sockets of claim 1, wherein the second socket further comprises a different number of lines between the first and second numerical indicia compared to the first socket.

3. The first and second sockets of claim 1, wherein the numerical indicia are disposed about 180 degrees apart.

4. The first and second sockets of claim 1, further comprising a third numerical indicia disposed on the outer surface.

5. The first and second sockets of claim 1, wherein the first line includes a pair of lines disposed between the first and second numerical indicia.

6. The first and second sockets of claim 2, wherein the second socket does not include any lines.

7. The first and second sockets of claim 5, wherein the second socket further comprises a second line disposed between the first and second numerical indicia.

8. The first and second sockets of claim 1, wherein the first line is a dashed line.

9. The first and second sockets of claim 1, further comprising raised portions respectively disposed on the outer surfaces of at least one of the first and second sockets.

10. The first and second sockets of claim 9, wherein the first and second numerical indicia and the first line are disposed on the raised portion of the of at least one of the first and second sockets.

11. The first and second sockets of claim 4, wherein the first, second, and third numerical indicia are spaced substantially equally apart.

12. The first and second sockets of claim 1, wherein the first and second numerical indicia and the first line are recessed into the outer surface.

13. The first and second sockets of claim 1, wherein the first and second numerical indicia of the first socket have a first color, and the first and second numerical indicia on the second socket have a second color that is different than the first color.

14. The first and second sockets of claim 1, wherein the first line is raised.

15. A set of sockets comprising:
first and second sockets respectively having first and second sizes, each of the first and second sockets including:
an outer surface,
a drive portion having a drive end,
a work piece engaging end, and
a first and second numerical indicia disposed on the outer surface,
wherein the first socket includes a first line disposed on the outer surface of the first socket and between the drive end and the first and second numerical indicia, or between the work piece engaging end and the first and second numerical indicia.

16. The set of sockets of claim 15, wherein the second socket has a different number of lines compared to the first socket.

17. The set of sockets of claim 15, wherein the first and second numerical indicia are disposed about 180 degrees apart.

18. The set of sockets of claim 15, further comprising third numerical indicia respectively disposed on the outer surfaces.

19. The set of sockets of claim 18, wherein the first, second, and third numerical indicia are spaced substantially equally apart.

20. The set of sockets of claim 15, wherein the first and second numerical indicia and the first line are recessed into the outer surface.

21. The set of sockets of claim 15, wherein the first and second numerical indicia indicate a size of the work portion of the socket.

22. The set of sockets of claim 15, wherein the first and second numerical indicia of the first socket have a first color, and the first and second numerical indicia on the second socket have a second color that is different than the first color.

23. The set of sockets of claim 15, wherein the first line is raised.

24. The set of sockets of claim 15, wherein the first line is a dashed line.
